(19) United States
(12) Patent Application Publication
(10) Pub. No.: US 2010/0034612 A1
(43) Pub. Date: Feb. 11, 2010

(54) CAGE NUT

(75) Inventor: Jean-Baptiste Pau, Bilieu (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/514,699

(22) PCT Filed: Oct. 25, 2007
(86) PCT No.: PCT/EP07/09247

§ 371 Date: May 13, 2009

(30) Foreign Application Priority Data
Nov. 18, 2006 (DE) 10 2006 054 486.2

(51) Int. Cl. F16B 37/04

(52) U.S. Cl. 411/108

(57) ABSTRACT

A cage nut has a nut holder (1) and a nut part (20), the nut part (20) being captively floatingly mounted in the nut holder (1) via an engagement arrangement formed by laterally protruding retaining tongues (4, 5) and stop tongues (16, 17, 18, 19) that project in a hook-like manner. Despite the relatively simple construction of the cage nut, a robust connection is thereby obtained between the nut part (20) and the nut holder (1), one that is tolerant of deformation of the nut holder (1) and is stable against high torques.

### CROSS-REFERENCE TO RELATED APPLICATION

This application is a U.S. National Phase Patent Application based on International Application Serial No. PCT/EP2007/009247 filed Oct. 25, 2007, the disclosure of which is hereby explicitly incorporated by reference herein.

### BACKGROUND OF THE INVENTION

1. Field of the Invention

The present invention relates to a cage nut.

2. Description of the Related Art

One cage nut is known from DE 20 2006 003 639 U1. The prior cage nut comprises a nut part having a nut shaft and two side plates, which are formed onto the nut shaft on mutually opposite sides thereof. Also present is a nut holder, which has a contact portion configured with a pass-through opening and against which the nut part rests. Lastly, there is an engagement arrangement that cooperates with the side plates to hold the nut part in a floating mounting, the engagement arrangement being formed by two side walls which are bent at right angles from mutually parallel edge sides of the contact portion, and which are provided with longitudinal slits through which the side plates engage. A floating mounting is contrived by properly dimensioning the spacing between the side walls and the size of the longitudinal slit.

### SUMMARY OF THE INVENTION

The present invention provides a cage nut, which, while being of simple construction, can be welded onto a support part without compromising functionality and is sufficiently stable against high tightening torques.

By virtue of the fact that the inventive cage nut is configured to comprise retaining tongues formed in a step-like manner and engaging behind the nut part and to comprise bent stop tongues that limit the travel of the side plates, the cage nut is relatively easy to manufacture, is relatively insensitive to deformations occurring during the welding-on process, and presents a sufficiently high resistance even to high torques.

In one form thereof, the present invention provides a cage nut including a nut part having a nut shaft and two side plates formed onto the nut shaft on mutually opposite sides of the nut shaft, a nut holder provided with a support portion which is configured with a pass-through opening and on which the nut part rests, and an engagement arrangement that cooperates with the side plates to hold the nut part in a floating mounting, characterized in that the engagement arrangement includes two mutually oppositely disposed retaining tongues each of which is configured with a pedestal portion that protrudes from the support portion and with an end portion angled away from the pedestal portion, the end portions extending toward each other, and is provided with four stop tongues which are disposed opposite each other in pairs and which extend, bent away from the support portion, in the same direction as the pedestal portions and confine the side plates on the longitudinal sides thereof that extend to the nut shaft.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a nut holder in an exemplary embodiment of a cage nut according to the invention;

FIG. 2 is a perspective view of the exemplary embodiment according to FIG. 1 with a nut part in engagement with the nut holder; and

FIG. 3 is a section of the exemplary embodiment according to FIGS. 1 and 2 in an installed situation.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

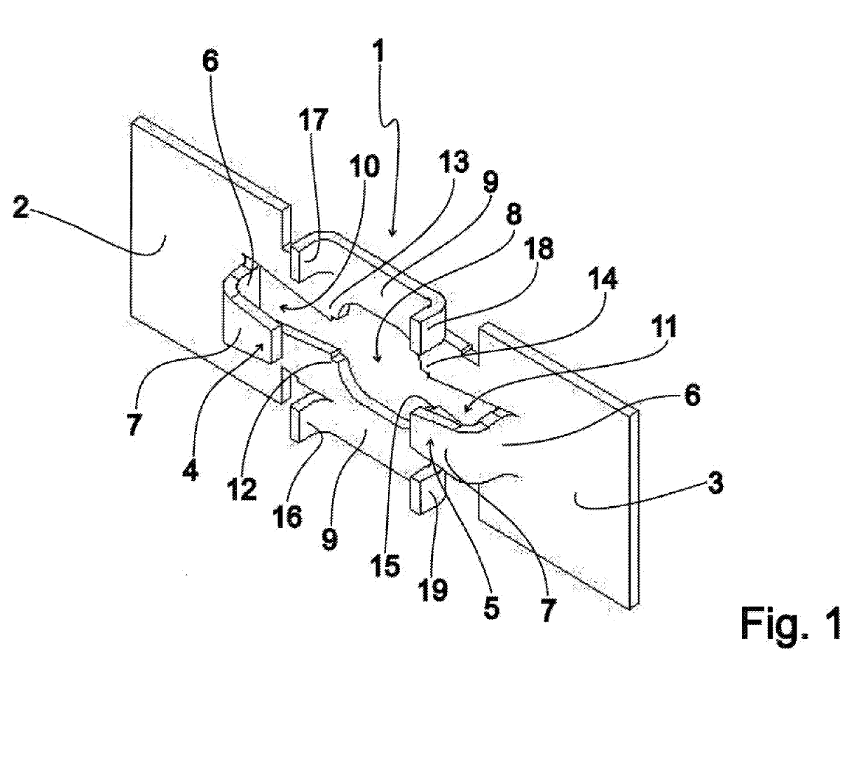

FIG. 1 is a perspective view of the nut holder 1 in an exemplary embodiment of a cage nut according to the invention. The nut holder 1 is made from a single piece of sheet metal of rectangular shape and has two laterally disposed side portions 2, 3 with an approximately square base area. By a punching and bending process, each of the mutually facing sides of the side portions 2, 3 is configured, approximately centrally, with a retaining tongue 4, 5, each said retaining tongue 4, 5 having a pedestal portion 6 that is oriented substantially at right angles to the side portion 2, 3, and an end portion 7 that extends at right angles from the pedestal portion 6, from the one side portion 2, 3 toward the respective other side portion 2, 3. The pedestal portion 6 and the end portion 7 of each retaining tongue 4, 5 are configured trapezoidally, with edge sides that merge one into the other to form a shape that tapers toward the respective free end, such that a pass-through opening 8 configured centrally in a support portion 9 disposed between the side portions is formed into mutually opposite side openings 10, 11 that widen trapezoidally in the direction of side portions 2, 3 and that open, via contact portions 12, 13, 14, 15 in the form of constrictions, into the pass-through opening 8, which is more largely dimensioned in terms of diameter.

Also provided in support portion 9 are laterally disposed stop tongues 16, 17, 18, 19, also produced by a stamping and bending process, which extend at right angles to support portion 9 and are arranged on the same side as the retaining tongues 4, 5. Said stop tongues 16, 17, 18, 19 extend for a distance from the support portion 9 that roughly corresponds to the projecting height of the end portions 7 of retaining tongues 4, 5, but at least to the length of the pedestal portions 6. The stop tongues 16, 17, 18, 19 are arranged, in the longitudinal direction of the cage nut 1, between and spaced apart from the free ends of the end portions 7 of the retaining tongues 4, 5.

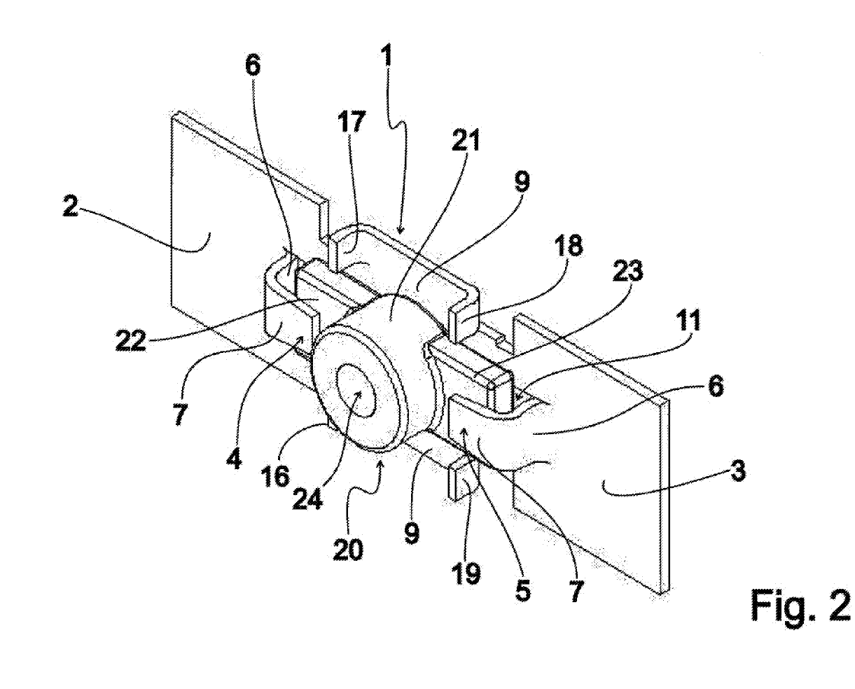

FIG. 2 is a perspective view of the nut holder 1 in the exemplary embodiment according to FIG. 1, comprising a nut part 20 that is mounted in the nut holder 1 captively, floatingly and in a rotationally locked manner by means of an engagement arrangement formed by the retaining tongues 4, 5 and the stop tongues 16, 17, 18, 19. The nut part 20 is formed by a cylindrical nut shaft 21 and by two side plates 22, 23 of approximately square shape, which are joined to mutually opposite sides of the nut shaft 21. The side plates 22, 23 are disposed at an end side of the nut shaft 21, and in the arrangement according to FIG. 2 are rearwardly engaged by the retaining tongues 4, 5. The nut shaft 21 is configured with a centrally disposed screw opening 24 that is provided with an internal thread and extends in the longitudinal direction of the nut shaft 21.

The dimensions of the nut shaft 21 and of the side plates 22, 23 are, at the same time, adapted to the retaining tongues 4, 5 and the stop tongues 16, 17, 18, 19 in such a way that the outer diameter of the nut shaft 21 is smaller than the distance between the mutually confronting end faces of the end portions 7 of the retaining tongues 4, 5, the distance between the pedestal portions 6 of the retaining tongues 4, 5 is greater than the dimension between the end faces of side plates 22, 23 that face away from each other, and the width of the side plates 22, 23 is smaller than the dimension between the stop tongues 16, 17, 18, 19 configured on mutually opposite edge sides of the nut holder 1 and disposed directly opposite each other. That being the case, the stop portions 12, 13, 14, 15 brace the nut part 20, particularly in the region of the join between the side plates 22, 23 and the nut shaft 21.

This results in a sufficiently robust floating mounting of the nut part 20 in the nut holder 1, and one whose dimensions can be adjusted relatively easily, the nut part 20 being relatively easy to connect to the nut holder 1 due to the fact that the bending of two stop tongues 16, 17, 18, 19 disposed on one edge side of the nut holder 1 does not take place until after the side plates 22, 23 have been slid in between the retaining tongues 4, 5.

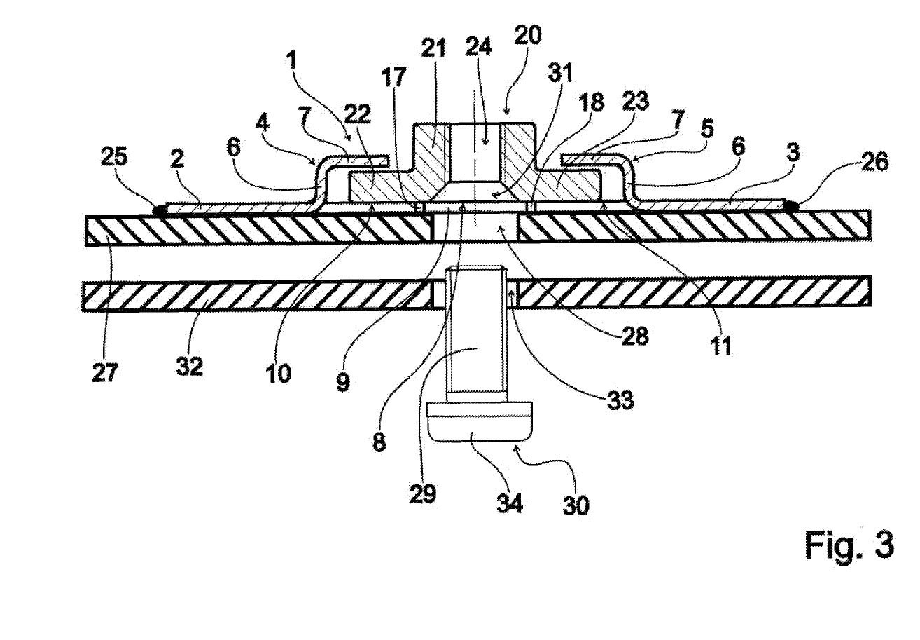

FIG. 3 is a section of an exemplary embodiment of a cage nut according to FIGS. 1 and 2 in an installed situation. In the overhead installed situation shown in FIG. 3, the side portions 2, 3 of the nut holder 1 are connected via weld seams 25, 26 to a carrier part 27, the side portions 2, 3 and the stop tongues 16, 17, 18, 19 being so arranged that the nut part 20 held by them is directed away from the carrier part 27. At the same time, the pass-through opening 8 is disposed in prolongation of a carrier part opening 28 configured in the carrier part 27, so that a screw shaft 29 configured with an external thread and belonging to a fastening screw 30 can be inserted via a lead-in funnel 31 configured in nut shaft 21 and flaring in the direction of pass-through opening 8, and can be brought into engagement with the internal thread configured in the screw opening 24. To connect an add-on part 32 to the carrier part 27 under these circumstances, the screw shaft 29 engages through an add-on part opening 33 configured in the add-on part 32 and having an inner diameter that is smaller than the outer diameter of a screw head 34 of the fastening screw 30.

It can be seen from FIG. 3 that due to the configuration of the engagement arrangement, with retaining tongues 4, 5 engaging behind the side plates 22, 23, the nut part 20 is secured in the axial direction against coming out of the nut holder 1, for example during the insertion of the fastening screw 30 into the nut shaft 21, or against dropping out of an installed position that is rotated 180 degrees with respect to the arrangement of FIG. 3. The stop tongues 16, 17, 18, 19, in turn, by forming a stop for the side plates 22, 23, block rotation and secure the nut part 20 against slipping out laterally. Play in the floating mounting of the nut part 20 in the nut holder 1 is provided in an extremely simple manner by suitable relative dimensioning of the retaining tongues 4, 5, the stop tongues 16, 17, 18, 19, the nut shaft 21 and the side plates 22, 23, such that deformation of the nut holder 1 can be compensated for relatively easily, for instance in cases where the weld seam 25, 26 has to be run on into the vicinity of the support portion 9 in order to achieve particularly high robustness during mounting on the carrier part 27.

It can also be understood particularly clearly from the representation according to FIG. 3 that the nut shaft 21 is configured with a relatively thick wall thickness, so that due to the high robustness of the inventive cage nut, brought about the robust stops formed by retaining tongues 4, 5 and stop tongues 16, 17, 18, 19, if the internal thread of screw opening 24 in nut shaft 21 should wear out, a new internal thread with a larger diameter can be cut in the event that, as is often the case, the nut part 20 is no longer accessible in the installation situation.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-7. (canceled)

8. A cage nut, comprising:
a nut part including a nut shaft and two side plates formed on mutually opposite sides of said nut shaft; and
a nut holder, comprising:
a support portion having a pass-through opening, said nut resting on said support portion; and
an engagement arrangement cooperating with said side plates to hold said nut part in a floating mounting, including two mutually oppositely disposed retaining tongues each configured with a pedestal portion protruding from said support portion and an end portion angled away from said pedestal portion, said end portions extending toward each other, said engagement arrangement further including four stop tongues disposed opposite each other in pairs and extending from said support portion in the same direction as said pedestal portions, said stop tongues confining said side plates on respective longitudinal sides of said stop tongues that extend toward said nut shaft.

9. The cage nut of claim 8, wherein said stop tongues and said retaining tongues are stamped from said support portion, said retaining tongues each having a shape that tapers from its respective said pedestal portion toward a free end of its respective said end portion, said retaining tongues forming inwardly projecting stop portions adjacent said pass-through opening with spacing between each pair of said stop portions smaller than a largest diameter of said nut part.

10. The cage nut of claim 9, wherein said end portions have a trapezoidal shape.

11. The cage nut of claim 10, wherein said pedestal portions have a trapezoidal shape, including edge faces shaped to merge with said end portions of said retaining tongues.

12. The cage nut of claim 8, wherein said pedestal portions and said stop tongues are oriented at right angles to said end portions of said retaining tongues, and said retaining tongues oriented parallel to said support portion.

13. The cage nut of claim 8, wherein said stop tongues extend away from said support portion a distance at least equal to said pedestal portions.

14. The cage nut of claim 8, further comprising at least one side portion formed on said support portion, said side portion so dimensioned that said nut holder can be welded to a support part by at least one weld seam spaced apart from said support portion.
